(19) United States
(12) Patent Application Publication
(10) Pub. No.: US 2017/0366069 A1
(43) Pub. Date: Dec. 21, 2017

(54) LASER-SPUN ELECTRIC GENERATOR

(71) Applicant: Daniel Paul Mansfield, Sandford, ME (US)

(72) Inventor: Daniel Paul Mansfield, Sandford, ME (US)

(21) Appl. No.: 15/581,692

(22) Filed: Apr. 28, 2017

Related U.S. Application Data
(60) Provisional application No. 62/351,136, filed on Jun. 16, 2016.

(51) Int. Cl. H02K 7/18; H02K 7/09; H02K 9/00; H02K 1/27; H02K 53/00

(52) U.S. Cl. CPC H02K 7/1807; H02K 9/005; H02K 1/27; H02K 7/09; H02K 53/00

(57) ABSTRACT

A laser-spun electric generator is provided. The laser-spun electric generator having a plurality of light sails mounted along an annular rotor frame also providing magnetic elements there along. The annular rotor frame may be magnetically and thus rotatably mounted between two opposing magnetic hubs within a solar cell housing. The annular rotor frame may be disposed within the lumen of a donut-shaped tubular coil. Each laser emitter may be mounted to the tubular coil so as to emit a laser beam directed transverse relative to a respective light sail of the plurality of light sails that rotate through the path of the laser beam, converting the linear energy of the laser to rotational motion energy, generating electricity as the plurality of magnetic elements pass through the tubular coil.

### CROSS-REFERENCE TO RELATED APPLICATION

This application claims the benefit of priority of U.S. provisional application No. 62/351,136, filed 16 Jun. 2016, the contents of which are herein incorporated by reference.

### BACKGROUND OF THE INVENTION

The present invention relates to electric generators and, more particularly, a laser powered electric generator apparatus.

More than ever, people are looking for solutions to their electricity needs, preferably “green” solutions with no or minimal carbon pollutants affording energy autonomy that liberates them from the “grid”.

As can be seen, there is a need for a laser powered electric generator apparatus.

### SUMMARY OF THE INVENTION

In one aspect of the present invention, a laser-spun electric generator including a housing enclosing a core unit; two opposing magnetic hubs mounted to the housing; and the core unit comprising: a donut-shaped coil mounted to the housing; a rotor frame disposed within a lumen of the coil, wherein the rotor frame is made of ferromagnetic material and centrically oriented between and relative to the two opposing magnetic hubs so as to levitate therebetween; a plurality of light sails radially extending from the rotor frame; a plurality of magnetic elements disposed along the rotor frame; and at least one laser emitter mounted to the coil so that each laser emitter emits a laser beam transversely relative to at least one respective light sail of the plurality of light sails.

In another aspect of the present invention, the laser-spun electric generator includes a housing enclosing a core unit, wherein the housing provides a vacuum for the core unit enclosed therein, and wherein the housing prevents outside light from entering the core unit; two opposing magnetic hubs mounted to the housing; the core unit comprising: a donut-shaped coil mounted to the housing; a rotor frame disposed within a lumen of the coil, wherein the rotor frame is made of ferromagnetic material and centrically oriented between and relative to the two opposing magnetic hubs so as to levitate therebetween; a plurality of light sails radially extending from the rotor frame; a plurality of magnetic elements disposed along the rotor frame; and at least one laser emitter mounted to the coil so that each laser emitter emits a laser beam transversely relative to at least one respective light sail of the plurality of light sails; a battery electrically connected to the at least one laser and the coil; and a cooling element configured to selectively keep an enclosed space of the housing at a sufficient temperature, wherein the cooling element is electrically coupled to the battery.

These and other features, aspects and advantages of the present invention will become better understood with reference to the following drawings, description and claims.

### BRIEF DESCRIPTION OF THE DRAWINGS

FIG. 1 is a front view of an exemplary embodiment of the present invention;

FIG. 2 is a cross-section view of an exemplary embodiment of the present invention, taken along line 2-2 in FIG. 1;

FIG. 3 is a cross-section view of an exemplary embodiment of the present invention, taken along line 3-3 in FIG. 2;

FIG. 4 is a perspective view of an exemplary embodiment of a core unit of the present invention, with parts broken away for clarity; and

FIG. 5 is a perspective view of an exemplary embodiment of a rotor frame of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a laser-spun electric generator having a plurality of light sails mounted along an annular rotor frame also providing magnetic elements there along. The annular rotor frame may be magnetically and thus rotatably mounted between two opposing magnetic hubs within a solar cell housing. The annular rotor frame may be disposed within the lumen of a donut-shaped tubular coil. Each laser emitter may be mounted to the tubular coil so as to emit a laser beam directed transverse relative to a respective light sail of the plurality of light sails that rotate through the path of the laser beam, converting the linear energy of the laser to rotational motion energy, generating electricity as the plurality of magnetic elements pass through the tubular coil.

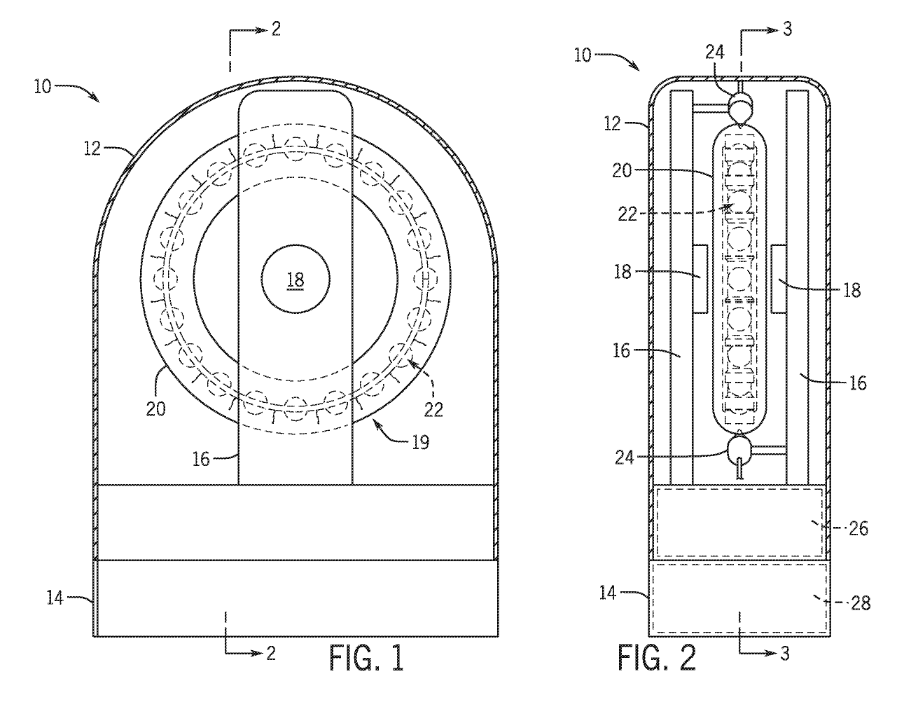

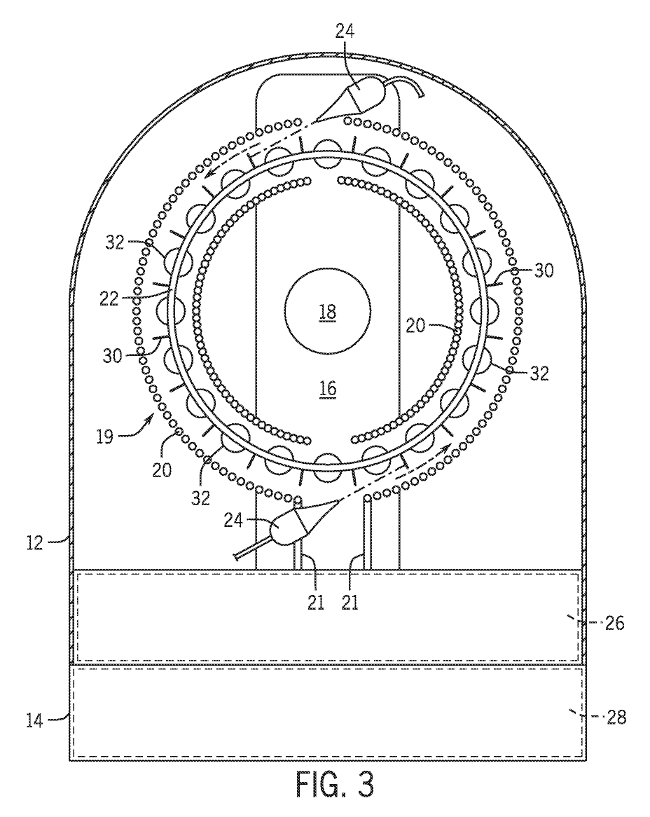

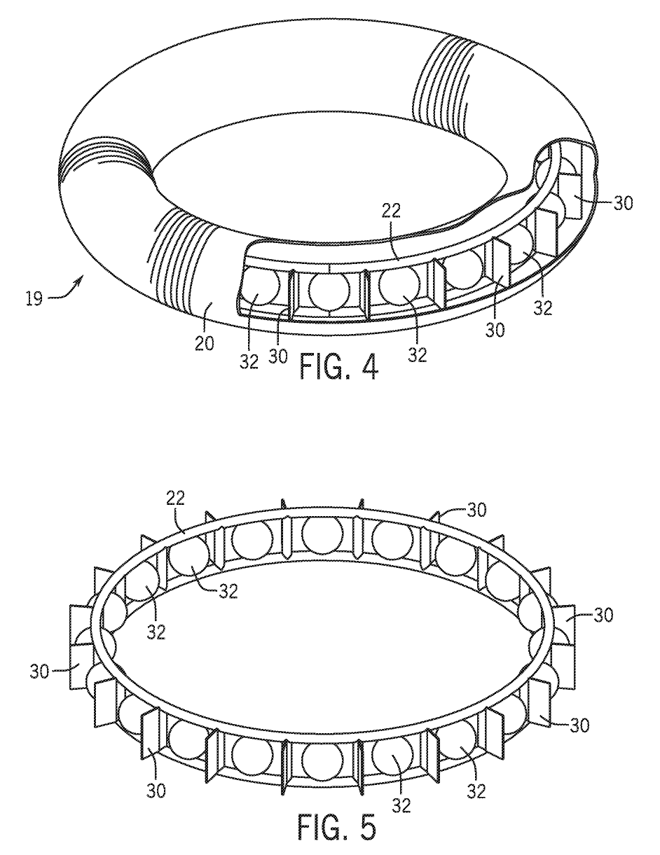

Referring to FIGS. 1 through 5, the present invention may provide an electric generator apparatus 10. The electric generator apparatus 10 may include at least one laser emitter 24 oriented to engage a series of spaced apart light sails 30 mounted on a rotor frame 22. The light sails 38 are mounted along the rotor frame 22 so as to be generally transverse to the direction of the laser emitted from the laser emitter(s) 24. The rotor frame 22 provides a plurality magnetic elements 32 disposed there along. The rotor frame 22 may be an annular frame made of ferromagnetic material rotatably mounted between two opposing magnetic hubs 18.

The magnetic hubs 18 may be mounted on respective vertical members 16 within a housing 12 encasing the electric generator apparatus 10, or at least the core unit 19 thereof (rotor frame 22 and coil tubular donut 20). The vertical members 16 may extend from a base 14 of the housing 12. Also mounted within the housing 12 is a coil tubular donut 20. The rotor frame 22 and thus its plurality of magnetic elements 32 are adapted to rotate within the lumen of the tubular donut 20, as illustrated in the FIGS, about a rotational axis defined by the two opposing magnetic hubs 18.

The electric generator apparatus 10 may include a battery 26 that is electrically connected to the at least one laser emitter 24 and to the coil tubular donut 20, via leads 21, connection wires or the like. The storage battery 26 provides electricity for the laser emitters 24 as well as storing energy. The electric generator apparatus 10 may include a cooling element 28 connected to the battery 26, so that the cooling element may keep the core unit at a predetermined suitable temperature. Both the cooling element 28 and the battery 26 may or may not be encased in the housing 12. The housing 12 may be a solar celled dome or shell, maintaining a vacuum about the core unit 19, while keeping out outside light as well.

The light sails (photon sails) 30 are adapted to provide propulsion using the electromagnetic radiation pressure exerted by laser emitted from the transversely mounted at least one laser emitter 24, capturing linear energy of the laser and transferring it in the form of rotational motion energy. With the rotor frame 22 rotatably levitated between the two opposing magnetic hubs 18, the rotational motion energy captured by the light sails 30 rotates the rotor frame 22 magnetic elements 32 within the coil tubular donut 20, generating electricity. The coil tubular donut 20 may be made from coiled copper or the like.

A method of using the present invention may include the following. The electric generator apparatus 10 disclosed above may be provided. The user may initiate the rotation of the rotor frame 22 (or the housing 12 may be adapted to initiate the rotation of the rotor frame 22) or the at least one laser emitter 24 may start to spin the rotor frame 22 via the light sails 30. The rotor frame 22 levitated inside the coil donut 20 inside the vacuum, gains rotational velocity speed. Around or over 10 miles an hour the present invention may sustains itself and start to generate extra electricity as its rotational velocity increases. Around 90,000 miles per second, the present invention may generate 11 million 400 thousand volts of electricity.

In other embodiments, the present invention may produce freed plasma, or basically anything that requires electricity or electrical energy, such as new composite materials from a centrifuge, robots, computers, mechanized equipment and weapons, and the like.

It should be understood, of course, that the foregoing relates to exemplary embodiments of the invention and that modifications may be made without departing from the spirit and scope of the present invention.

1. A laser-spun electric generator, comprising:
a housing enclosing a core unit;
two opposing magnetic hubs mounted to the housing; and
the core unit comprising:
a donut-shaped coil mounted to the housing;
a rotor frame disposed within a lumen of the coil, wherein the rotor frame is made of ferromagnetic material and centrically oriented between and relative to the two opposing magnetic hubs so as to levitate therebetween;
a plurality of light sails radially extending from the rotor frame;
a plurality of magnetic elements disposed along the rotor frame; and
at least one laser emitter mounted to the coil so that each laser emitter emits a laser beam transversely relative to at least one respective light sail of the plurality of light sails.

2. The laser-spun electric generator of claim 1, wherein the housing provides a vacuum for the core unit enclosed therein.

3. The laser-spun electric generator of claim 1, wherein the housing prevents outside light from entering the core unit.

4. The laser-spun electric generator of claim 1, further comprising a battery electrically connected to the at least one laser and the coil.

5. The laser-spun electric generator of claim 1, further comprising a cooling element configured to selectively keep an enclosed space of the housing at a sufficient temperature.

6. The laser-spun electric generator of claim 5, wherein the cooling element is electrically coupled to the battery.

7. A laser-spun electric generator, comprising:
a housing enclosing a core unit, wherein the housing provides a vacuum for the core unit enclosed therein, and wherein the housing prevents outside light from entering the core unit;
two opposing magnetic hubs mounted to the housing;
the core unit comprising:
a donut-shaped coil mounted to the housing;
a rotor frame disposed within a lumen of the coil, wherein the rotor frame is made of ferromagnetic material and centrically oriented between and relative to the two opposing magnetic hubs so as to levitate therebetween;
a plurality of light sails radially extending from the rotor frame;
a plurality of magnetic elements disposed along the rotor frame; and
at least one laser emitter mounted to the coil so that each laser emitter emits a laser beam transversely relative to at least one respective light sail of the plurality of light sails;
a battery electrically connected to the at least one laser and the coil; and
a cooling element configured to selectively keep an enclosed space of the housing at a sufficient temperature, wherein the cooling element is electrically coupled to the battery.
